(19) United States
(12) Patent Application Publication
(10) Pub. No.: US 2004/0036612 A1
(43) Pub. Date: Feb. 26, 2004

(54) Human tracerii

(76) Inventor: Samir G. Elias, Hialeah, FL (US)

Correspondence Address: SAMIR G. ELIAS, P.O. BOX 133426, HIALEAH, FL, 33013, US

(21) Appl. No.: 10/210,485

(22) Filed: Aug. 2, 2002

(51) Int. Cl. G08B 23/00

(52) U.S. Cl. 340/573.1

(57) ABSTRACT

The new idea is having offices nation wide called Human Tracer II Stores you walk in and fill out a form of personnal information and pay a fee you get injected with a transmitter and get bandaged like getting a blood test except you are getting a transmitter in you and your not injected into a vain but (yes inside the skin) and yes it can be injected anywere in the body Or It can be placed in the shoes or watch or part of closing etc, the first thing a family member or a friend needs to do when a loved one is missing is to.

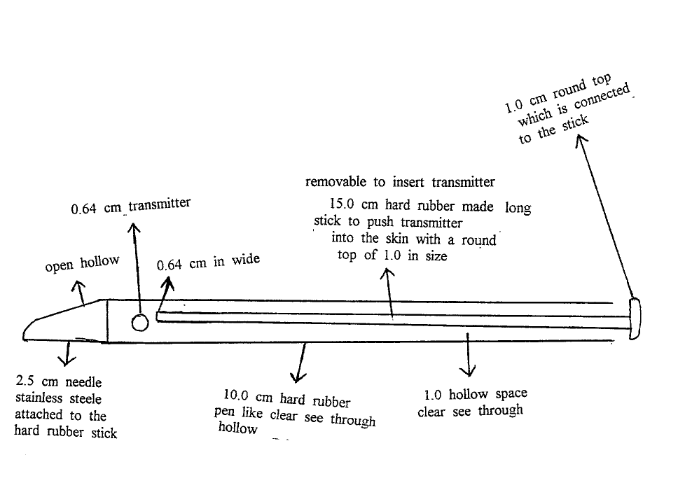

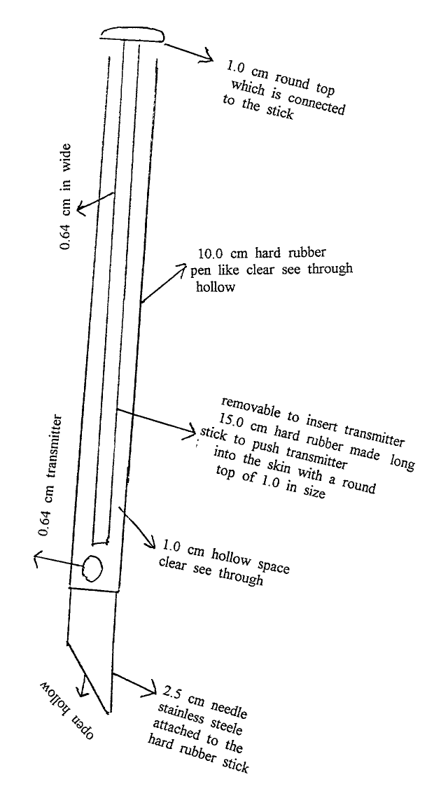

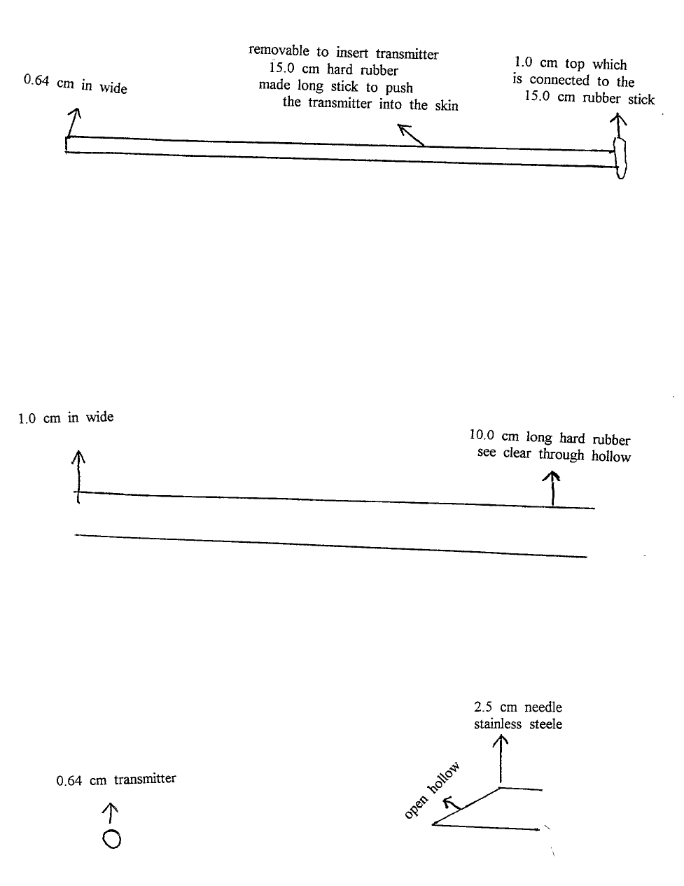

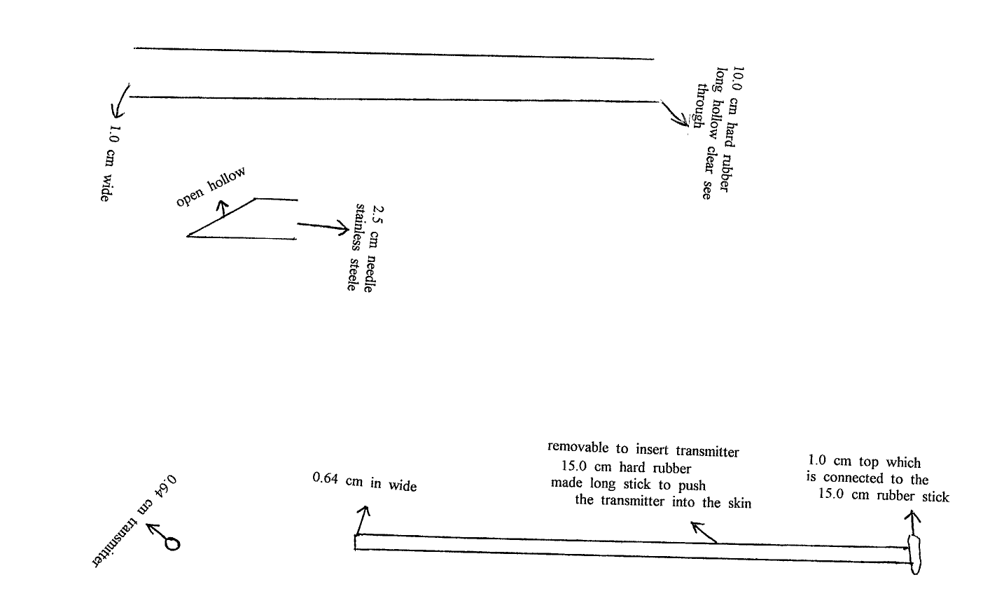

1 Notify the police Asap.

2 The Human tracer will get turned on and in matters of minutes were able to locate that child, teenager, or adult. where the police can apprehend the criminal before any violent or a criminal act is commited and it can save many human lifes.

3 Without a police report and a law enforcement agency officer present the tracer will not be turned on (No Exception).

### BACKGROUND OF THE INVENTION

1) 1 Animal tracker which is attached to an animal and let loose in the wild and several month down the line able to locate that animal. 2 It's also used on fish, dolphins and sharks in the ocean. 3 also used on automobiles to locate them.

### BRIEF SUMMARY OF THE INVENTION

2) 1 It's a transmitter device just like the list above except it's for human and can be inserted inside the skin in order to pin point and locate children, teenagers, and adults. 2 it can be inserted into the skin using the plastic pen like with a needle attached on the tip of it which it can be disposable after each use drawing is attached.

### BRIEF DESCRIPTION

It's a ⅜ transmitter in size and layered in soft bone type and color which can be picked up for miles worldwide like cell phones.

### DETAILED DESCRIPTION OF THE INVENTION

The human tracer II will be used to locate a missing child, teenager or an adult with a use of a computer system and satelite.

1. What i claim is my invention is the Idea of the human tracer II is for a human to have a transmitter On or In the body just like an animal, fish or an automobile.
1 On As in the shoes or watch or closing etc.
2 In As in the skin but Not Into The Vain as of anywere inside the human skin etc.
